(19) United States
(12) Patent Application Publication
(10) Pub. No.: US 2006/0161470 A1
(43) Pub. Date: Jul. 20, 2006

(54) Method and system for creating and maintaining customer tailored marketing plans

(75) Inventors: David M. Smith, Naperville, IL (US); Joanne T. Wise, Chicago, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: United States Gypsum Company, Chicago, IL (US)

(21) Appl. No.: 11/039,382

(22) Filed: Jan. 19, 2005

(51) Int. Cl. G06F 17/30

(52) U.S. Cl. 705/10

(57) ABSTRACT

A method and system for creating a customer-specific marketing plan includes obtaining customer-specific information in response to a series of queries, weighting the customer-specific information in accordance with a predetermined weighting system, and generating date-specific marketing plan, that includes tools and other aspects.

### TECHNICAL FIELD OF THE INVENTION

The present invention relates generally to a system and method for enhancing a vendor/customer relationship. In particular, the invention relates to a method and system for determining an optimal marketing plan specific to a customer based upon customer responses to a predetermined set of queries provided by a vendor.

### BACKGROUND OF THE INVENTION

A primary objective in any vendor/customer relationship is to determine and achieve the goals of the customer in a timely and efficient manner. For this reason, vast resources are allocated to sales and marketing departments in many corporations and other organizations to ensure that customer needs are adequately satisfied. For enhancing customer relationships, sales forces will typically meet with their customers on a regular basis in order to establish annual or other recurring marketing plans that will provide optimum value to the customers, while enhancing the vendor/customer relationship.

Often, however, it is difficult to quickly and efficiently determine an optimum marketing plan with respect to any individual customer. This is due, in part, to the difficulties in determining appropriate intermediate and/or long-term goals and objectives in any specific vendor/customer relationship. For this reason, substantial amounts of time are spent in obtaining information that relates to a customer's needs. However, such information is often not easily collected nor used in an efficient manner to create an ideal plan for any particular customer. Indeed, at present, such marketing plans are often the result of essentially guesswork on the part of sales personnel, without maintaining any degree of tracking across the customer base of the organization.

### BRIEF SUMMARY OF THE INVENTION

The inventive method and system provides a platform from which a sales team may efficiently communicate with customers to develop a marketing plan that conforms to a particular customer's needs. More specifically, it is an object of the invention to create a program that delivers value to the customer by collecting customer-specific information and tailoring a program that meets the objectives of such information.

The present invention provides a method and system for creating a customer-specific marketing plan. The method includes obtaining customer-specific information through a series of queries, typically asked of the customer by sales personnel. Next, the method processes the responses to the queries, preferably by weighting the customer-specific responses in accordance with a predetermined weighting algorithm. The method then generates a marketing plan tailored to a specific customer, which may include recurring programs, tools and other aspects. Programs have specific targets or areas of influence that occur within defined time periods, such as one day or twelve months. Tools, on the other hand, are intended to relate to services or tangible assets that may be offered to the customer apart from any time frame.

Optionally, the method may further create an electronic document that contains the marketing program. According to one specific alternative of the invention, electronic mail alerts may be automatically generated to inform appropriate personnel of an event that has been scheduled according to the plan. Also, the method may be used to periodically update an existing marketing plan, depending on current needs of a particular customer.

The present invention also provides a system for establishing a marketing plan for a specific customer. The system is implemented in one or more computing devices, one of which is used by sales personnel. The computing device provides a user interface that presents a predetermined series of queries to the user. The device is disposed to receive responses to the queries to create an electronic customer file containing profile information for the particular customer. In one embodiment, the computing device transmits the electronic customer file to a server that is coupled with a customer database. In response, the server processes the customer file by, among other things, accessing the database for information unique to the particular customer. A server application thereafter creates an output customer file containing a proposed marketing plan that is tailored to the specific customer. The marketing plan is transmitted to the user's computing device and modified as desired. Once completed, the computing device may create an electronic document containing the marketing program for the customer.

### BRIEF DESCRIPTION OF THE DRAWINGS

FIG. 1 is a system diagram that may be used to implement the invention.

FIG. 2 is a flow diagram illustrating a method according to the invention.

FIG. 3 is another flow diagram illustrating the creation of alerts that may be created by the method shown in FIG. 2.

FIG. 4 is an exemplary screen display that is presented to a user of the system according to the present invention.

### DETAILED DESCRIPTION OF THE INVENTION

Generally, the present invention provides a method and system for creating a customer-specific marketing program. The method includes obtaining customer-specific information through a series of queries provided by an application running on a computing device operated by sales personnel. Based on the responses to the queries, the invention assigns weighting factors to various marketing programs and tasks in accordance with a predetermined weighting system. The method then generates a marketing program, as well as tools and other aspects specific to the customer. That is, marketing programs having specific targets or areas of influence that will occur between specific time intervals are provided in the marketing program. Other tools, such as services or tangible assets that may be offered to the customer apart from any time frame, may also be created.

While not limited thereto, the invention may be implemented in connection with a relationship between a vendor and a customer in a distribution chain of goods. For example, a manufacturer of gypsum board and related building and construction products may use the invention to establish an enhanced relationship with a distributor of such products.

The present invention provides a platform from which a sales force for an organization communicates with customers in a distribution chain. By tailoring the output program provided by the system and method to the needs of the customer, the invention provides an individualized marketing program that delivers value to the customer. By achieving this end result, the vendor may increase its market partnerships and thereby increase its revenue.

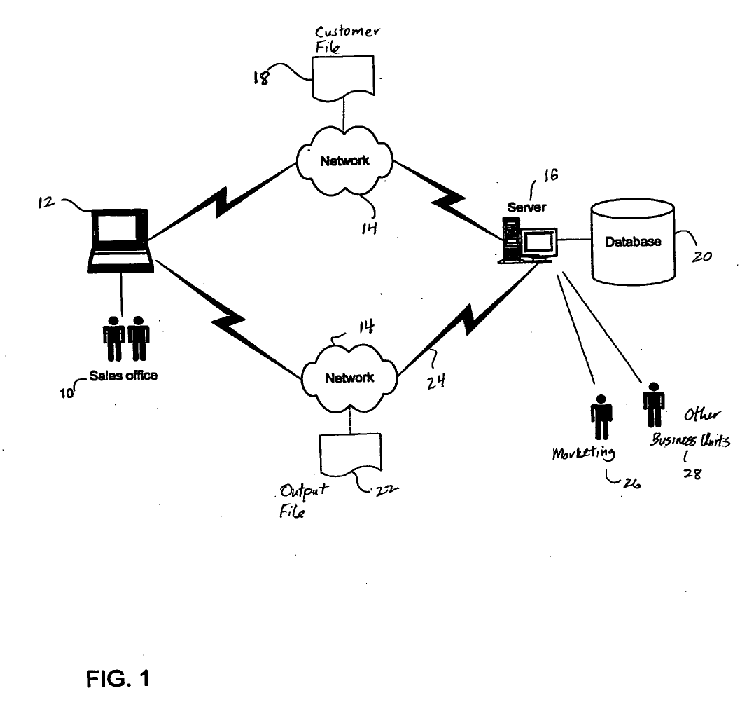

FIG. 1 broadly illustrates certain features of a preferred embodiment of the invention. A user 10 who may be associated with a sales office or the like, operates a first computer 12, which is a laptop computer or other computing device in a preferred embodiment. As explained in greater detail below, the user in consultation with a customer, interacts with an application program running on the computer in such a way that the program generates a series of queries for the customer.

The computer 12 is linked via a network 14 to a remote server 16, for example, through a virtual private network connection. By way of the network connection, a customer file 18, containing customer-specific response information, is transmitted to the server 16. The server 16 includes or is linked to a database 20. At the server 16, the information contained in the customer file 18 regarding responses to the predefined queries is extracted. The server 16 (and various applications running thereon) operates in a logical fashion to process the information and query the database 20 for output information, including program and task information. From this, an output file 22 is transmitted back to the first computer 12 via a network connection 24.

In addition to communicating with the user 10 located at a sales office or other remote site, the server 16 may optionally be accessed by marketing personnel 26 and personnel in other departments. As explained further below, such access permits the database 20 to be updated with customer-specific preferences and other information useful to track and maintain the needs of particular customers.

As discussed below, other materials, such as documentation relating to the output file may be generated and transmitted to the computer 12. Similarly, the computer 12 may optionally generate an output document (such as a document generated in .pdf format) for delivery to the customer. The output file 12 contains a marketing plan for the particular customer in a given time period. Information relating to the output file is then periodically transmitted to the salesperson for execution of the proposed plan at regular or irregular intervals.

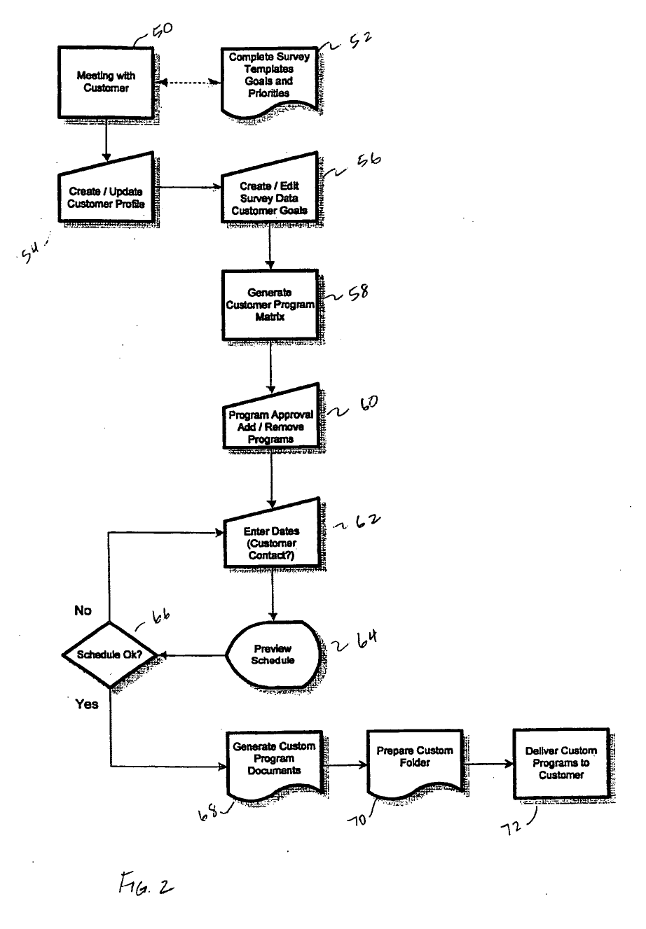

While FIG.1 illustrates the invention implemented in a network configuration, it should be understood that the invention is not limited to such an arrangement. That is, the functionality of the remote computer 12 and the server 16 may be implemented in a single computing device. In this embodiment, the processing steps described below in conjunction with FIG. 2 are carried out by the single computing device.

In a preferred embodiment, the invention operates to “set a playing field” for sales personnel through delivery of a discussion guide that focuses on understanding the business needs of a particular customer. Then, based on input received from the customer in response to queries posed by the guide, the invention creates an output marketing plan to a salesperson that targets a selected number of business objectives for a particular customer in a particular year or other interval as defined by the plan. Next, a series of recommended programs prompts the sales representative for selection—with the option of alternative, although perhaps less strategic, programs. In this way, the invention provides a 12-month, custom-tailored strategy deliverable to the customer. Based on alerts that are automatically provided, the marketing plan may then be reviewed by the salesperson throughout the course of the year for effectiveness and/or change of strategic direction and updated as appropriate.

FIG.2 illustrates a flow diagram of the processing steps carried out by a method according to the invention. The method begins at a block 50 at a step in which sales personnel meet with a particular customer in order to develop a marketing plan for the customer. During the meeting, the sales personnel assist the customer in completing a Customer Survey, as shown at a block 52.

In the preferred embodiment, the Customer Survey is a series of queries that are presented in a logical sequence through a user interface of an application running on a computing device. Such queries typically include both open-ended and closed-ended questions that may, at certain locations, cause branches of a tree-like query structure to be displayed. The Customer Survey can therefore be thought of as a discussion guide that provides an in-depth look at the customer's business objectives, on a local basis, for any regular interval such as a 12-month period. In a preferred implementation, the application program provides a listing of 12 possible plan objectives from which at least three are selected by the customer. The selected plan objectives are thereafter prioritized according to the customer's needs.

The Customer Survey therefore helps to change the conversation from a tactical discussion, as would be typical in an annual meeting between sales personnel and a customer, into a series of questions that aid in the development of a long-term strategic marketing plan.

For aiding in its development, the Customer Survey is preferably built through a profile database of key customers of the organization. This increases the functional use of the Customer Survey as reporting can be linked to specific geographic locations or other demographics for sales information or program implementation to a national scope. This permits corporate long-term planning to be achieved on a more uniform scope.

The specific queries presented to the sales personnel and customer preferably include both questions that require a discrete yes/no response as well as open-ended questions concerning the customer's needs for an upcoming year, among other things. Such responses are input to an application program running on a computer of the sales personnel, as shown by computing device 12 in FIG. 1.

The method then proceeds to a block 54 wherein the computing device 12 creates a Customer Profile for the customer. This may include details concerning contact information for key personnel, the location, size and perhaps other demographic information concerning the customer.

As a result of receipt of the customer-specific input information through responses to the Customer Survey, the method creates a Survey Data file as shown by block 56. In general, the Survey Data file contains customer-specific responses to the Customer Survey and optionally defined customer goals, which may be part of the information received in accordance with the survey responses. The Survey Data file may be reviewed and edited by the sale personnel as desired.

In one embodiment, the Survey Data file is transmitted to a server for processing. Alternatively, the application executing on the sales person's computer, such as computer 12, may perform such processing tasks. In either embodiment, the Survey Data is used to generate a Customer Program Matrix, as shown by a block 58. This is achieved by processing the survey data through the assignment of certain rankings or weightings to possible marketing programs and/or tools, and through access to the database 20 containing customer preferences.

Specifically, upon receipt and parsing of the Survey Data file, the application program performs an algorithm based on a priority ranking or weighting of various possible programs and/or tools according to a customer's needs. In this way, marketing programs and/or tools are recommended for use in a created plan through the weighting assigned by the system. In one preferred embodiment, exemplary programs are prioritized according to a ranking of “one” to “five.” Thus, by way of example, if upon processing the received Survey Data file the system determines that customer relationship development and margin improvement is assigned priority weightings of “one” and “two,” respectively, then the system may recommend available programs corresponding to a promotional event such as a NASCAR event and a dealer training seminar program, respectively. However, if the system determines that margin improvement and relationship development are assigned priority weightings of “one” and “two”, respectively, then the system may recommend a series of contractor product training seminars as a type of program that fulfills both the margin improvement through the promotion of higher-margin products as well as relationship development. In this example, the recommended training program achieves multiple customer objectives through increased one-on-one time between the customer and a particular contractor of the customer to enhance that relationship and to also provide value through productivity training.

The invention, in a preferred embodiment, provides intelligent recommendations for the three different areas of influence: 1) Programs; 2) Tools; and (3) Other. As used herein, a program has a target or area of influence of a specific time interval—typically between one-day and 12-months—but nonetheless have a set time period. A tool typically does not. That is a recommended tool, as used herein, refers to a recommended service or tangible asset that the vendor can offer to the customer without regard to a specific time frame. An example of an “Other” area of influence may be joint sponsorship between the vendor and the customer of a charitable function or even a weekend excursion with the customer to further that relationship. This category may also refer to local programs that may not be large-scale or strategic enough to be funded via the marketing program. However, this area permits value that the vendor delivers on a local basis to be emphasized to the customer, to the extent that the customer desires such influence.

Thus, the system uses the received Survey Data file to logically assign priority weightings to a plurality of established programs and tools generally made available by the organization to the market, as well as local programs and other areas of influence. In so doing, the system creates a Customer Program matrix of possible programs and/or tools that will be implemented into a marketing plan.

Once the Customer Program Matrix is created, the method proceeds to a block 60 in which the customer program is approved or modified. Next, appropriate dates associated with the approved customer program are entered at a block 62. Optionally, the customer may be consulted at this point in time for approval of the program.

The customer program is then ready to be previewed, as shown by a block 64. The system then proceeds to a decision block 66 and determines whether the customer program schedule is suitable. If it is, processing continues to a block 68 to create custom program documents for the program. Otherwise, the method returns to the block 62 to permit alternative dates and/or other information to be entered into the customer program.

Upon completion of the Custom Program documents, the method continues to a block 70 to arrange the Custom Program documents and other related information into an electronic folder. Thus, upon receipt of critical customer-specific information and the completion of weighting for the appropriate areas of influence, a sales representative reviews the information and then creates an electronic document (such as in .pdf or other suitable format). This document is custom-tailored to the individual with whom the marketing plan was discussed, the name of the company, the key objectives that the vendor and customer will focus on during the plan. Preferably, the document does not simply enumerate a group of possible programs, but rather a detailed description as well as a calendar of events.

The Custom Program document or documents are delivered to the customer in a draft version for review at a block 72. Once the document has been agreed upon, or necessary adjustments made, the sales representative activates the program and delivers it in a prepared folder to the customer for implementation.

Last, at the end of the 12-month cycle, the sales representative meets with the respective customer to further review the past 12-month program. Questions such as whether the customer's objectives for the next 12-months have changed, whether the objectives were met, what can be done to improve the programs, are new programs needed, and the like are discussed. The existing plan is retired and a new draft plan is initiated. The system then returns to the beginning and repeats.

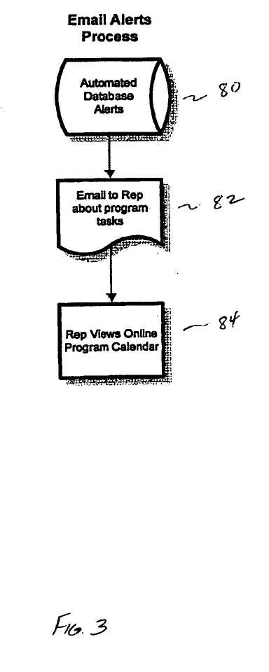

FIG. 3 illustrates an email alerting method according to one embodiment of the invention. In a first block 80, the server 16, which is linked to database 20, operates to generate automated alerts associated with the Customer Programs created by the system. At the appropriate time, such alerts are sent via an electronic mail service or other appropriate means to the sales personnel, as shown at a block 82.

At a next step denoted by a block 84, the sales personnel may access a Program Calendar via the network connection 24 to the server 16. In one embodiment, the alerting method provides a follow up or post event email message to the sales personnel after the scheduled date of a particular program. The email message or alert requests confirmation that the Program actually occurred as scheduled. In response, the sales personnel also provides feedback concerning program. Such feedback includes comments relating to the success of the event and any suggested changes that should be made for future programs. This information is processed by the system in order to further tailor programming plans for specific customers and/or for the organization.

In accordance with another feature of an embodiment of the invention, the generated marketing plan may be updated, either periodically or at a user's request. Also, throughout the course of a year, as programs are either to be executed or have been executed, an email prompt is delivered to the sales representative requesting information. The first prompt provides detailed task information for upcoming programs and events. The second prompt requests feedback to allow the corporation to review how effective programs are, areas of improvement, and an analysis of the dollars spent. This improves the corporate, and specifically the marketing departments, planning process.

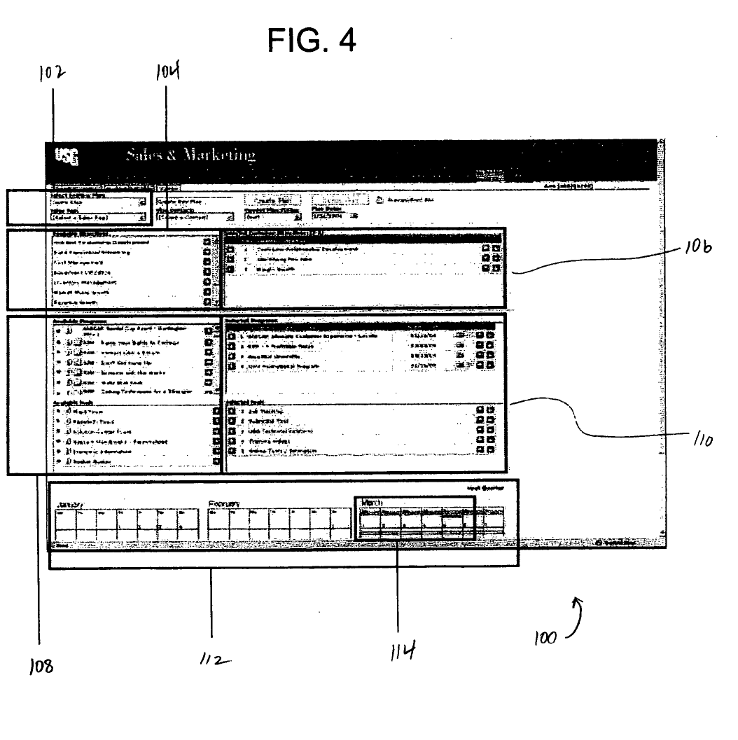

FIG. 4 illustrates one exemplary screen display that may be presented to a user in accordance with the invention. This screen display 100 permits customization of a marketing plan for a customer from a single screen. As shown, the screen is segregated into various zones or functional areas to permit completion of one function before selection and/or entry of information concerning the plan. For example, a first functional area 102 identifies the plan itself and information concerning the sales personnel. A second functional area 104 provides a listing of available objectives that may be selected through buttons associated each objective. As explained above, the list of objectives is presented based on processing the responses to the discussion guide with the particular customer. A third functional area 106 presents a listing of customer objectives that have been selected together with a priority ranking of the objectives.

The screen display includes other functional areas to enable ready access to the relevant information concerning the marketing plan. In FIG. 4, a functional area 108 presents a listing of available programs and tools offered by the organization. In a preferred embodiment, the user may hover over or select an icon, associated with the names of the available programs and tools, for providing additional information concerning the program or tool. A functional area 110, preferably disposed proximate the functional area 108, presents the user with programs and tools that have been selected. When the plan is finalized, these programs and tools are those recommended to the customer.

A further functional area 112, in this embodiment disposed at the bottom of the screen, provides a calendar view of the dates on which events are planned. In a preferred embodiment, one quarter of the schedule for a customer may be viewed from this screen area 112. As shown, the calendar display functional area 112 provide details 114 that graphically represent the various planned events for a particular customer. Such details may be color-coded or otherwise coded to reflect particular types of events.

Various advantages flow from the system and method described. For example, the organization may readily maintain centralized control over various marketing programs for its customer base, while enabling individualized programs to be implemented as required by the customers' needs. In addition, the invention enables centralized tracking control of the various programs being implemented throughout the organization. This may be utilized to simplify accounting functions as well as planning and budgeting tasks.

Therefore, a program planning tool according to the invention that aligns training and other programs and tools with the business objectives of a customer has been described. The planning tool creates a training experience that is tailored to a customer's specific requirements, while developing a relatively consistent approach to customer training across a customer base. In addition, the planning tool enables evaluation of program and plan results with various feedback mechanisms during the plan. Finally, the invention provides a planning tool that is easy to implement and use.

While this invention has been described with an emphasis upon preferred embodiments, it will be apparent to those of ordinary skill in the art that variations of the preferred embodiments may be used and that it is intended that the invention may be practiced otherwise than as specifically described herein. Accordingly, this invention includes all modifications encompassed within the scope of the invention as defined by the following claims.

What is claimed is:

1. A method for creating a marketing plan for a customer in a vendor-customer relationship including the steps of:
querying the customer in accordance with a series of preselected queries,
receiving input from the customer in response to the preselected queries,
based on the input received from the customer, weighting a plurality of programs and tasks according to a ranking system, and
providing a marketing plan including one or more of the plurality of programs or tasks.

2. The invention of claim 1 wherein the marketing plan is modified at specific intervals.

3. The invention of claim 1 further including the step of creating an electronic document containing the marketing plan.

4. A system for establishing a customer-specific marketing plan comprising:
a computing device including an application program operable to present a user interface having a predetermined series of queries, to receive input information in response to the series of queries, and to create a customer-specific marketing program by processing the query responses.

5. The invention as in claim 4 wherein the computing device further generates an electronic document containing the marketing program.
